(19) United States
(12) Patent Application Publication
(10) Pub. No.: US 2018/0260796 A1
(43) Pub. Date: Sep. 13, 2018

(54) Tipping for Media Content

(71) Applicants: Jarom McDonald, Spanish Fork, UT (US); Theron Brent Harmon, Lehi, UT (US); Jeffrey Harmon, Lehi, UT (US); Neal Harmon, Provo, UT (US)

(72) Inventors: Jarom McDonald, Spanish Fork, UT (US); Theron Brent Harmon, Lehi, UT (US); Jeffrey Harmon, Lehi, UT (US); Neal Harmon, Provo, UT (US)

(21) Appl. No.: 15/454,677

(22) Filed: Mar. 9, 2017

(51) Int. Cl. G06Q 20/10; H04L 29/06; H04L 29/08; G06F 3/0484

(52) U.S. Cl. CPC G06Q 20/10; G06F 3/04847; H04L 67/22; H04L 65/60

(57) ABSTRACT

A system and method for eliciting and receiving tips for media content. A server may provide media content to a consumer by streaming a movie to the consumer's device such as a computer, smartphone, tablet, or television. At a trigger point during the movie, the server may present a tipping interface to the consumer. A tipping interface may provide elicitation content and interface controls to accept tipping input. Elicitation content may be media content designed to inspire the consumer to provide a tip. The tipping interface may also provide information for guiding the consumer as to the amount of a tip. Interface controls in the tipping interface may accept tipping input from the consumer, which may include a tip amount, a reason for the tip, and suggestions related to the streamed movie or the streaming or filtering of the streamed movie. The server may receive the tipping input from the consumer and may effect a financial transaction based on the received tipping input.

### BACKGROUND OF THE INVENTION

The present disclosure relates to a system and method for eliciting, facilitating, providing, and receiving tips for media content.

The notion of tipping is entrenched in some industries and settings, e.g., food service or hotels. At many restaurants, a patron orders food and drink based on prices in a menu. In addition to the menu prices, the patron is expected to tip the server, i.e., give extra money to the server in exchange for the quality of service, or the quality of food, or the restaurant ambiance, or any other features of a restaurant meal or experience.

Similar tipping often occurs in hotels. For example, patrons may provide a tip for room service, or for a valet service, or for assistance in moving their luggage.

Tipping occurs in many other circumstances, often involving a service, e.g., taxi cabs or a coffee shop barista.

These physical services are not, however, the only services for which patrons appreciate and may be willing to, or feel morally obligated to, or even compelled to, provide or otherwise pay a tip for a service or product. For example, a viewer/consumer/patron may be willing to or desirous to pay a tip for media content, e.g. for streaming a movie, filtering a movie, or otherwise providing media content. Although the persons or individuals responsible for providing the media content are generally not physically accessible at the point of consumption of the media content, the consumer of the media content may experience a feeling of gratitude or moral obligation, or may be subject to some other motivation that may incite the consumer to provide a tip or another “little extra” in response to the media content, or to the manner in which the media content was provided.

For example, a consumer of a streamed movie may be appreciative of the availability of the movie, the technical quality of the streaming, the quality of a user interface, the quality of the content itself, the availability of filtering for the movie, filtering options and effectiveness, pre-configured filters, the cost of streaming and/or filtering, or any other aspect of consuming media content related to the viewing/consumption experience.

Unlike the restaurant, hotel, or taxi cab scenario, in the media content consumption scenario, e.g., watching a streamed movie, the service provider is not physically present to elicit and/or receive tips from the consumer of the media content. What is needed is a solution for eliciting and receiving tips in the context of media consumption, e.g., in the context of streaming a movie.

### BRIEF SUMMARY OF THE INVENTION

A method and system for eliciting and receiving a tip for media content is disclosed.

In one embodiment, a server may stream a movie, television show, or other audiovisual content to a consumer through a consumer's device. A consumer's device may be a computer (including monitor and speakers), a television, a smartphone, a tablet, projector, or any device for playing audiovisual content. The audiovisual content may be streamed over the Internet or other network or communication, or information transfer system as are well known in the art.

The streamed audiovisual content may include a trigger for launching a tipping interface. When a trigger is encountered, the server may present a tipping interface to the consumer of the audiovisual content.

A tipping interface may provide information to the consumer related to tipping, may include elicitation content to motivate or inspire the consumer to tip, and may include controls for the consumer to input a tip amount, a tipping reason, a tipping target, comments, and/or suggestions.

In one embodiment, the tipping interface may include elicitation content such as an audiovisual message from an actor, producer, or another person or group related to the streamed content, or the streaming technology, or filtering technology, or any person or group that may provide information or elicitation related to tipping.

The tipping interface may also include tipping estimate information to guide the user in determining an amount for a tip. Tipping estimate information may include, but is not limited to, information about the user (e.g., demographics, geography), the user's tipping history, tipping information for other consumers, tipping information for the same, similar, or other content, tipping information based on time of day, week, year, and any other information that may assist or guide the consumer in selecting an amount for tip.

The tipping interface may also include one or more controls for selecting a recipient or target for the tip, e.g., a particular actor, or the streaming technology developer or provider, or the music composer, or the filtering technology developer or provider, or a producer, or any other person or entity that associated with the audiovisual content, or streaming the audiovisual content, or filtering the audiovisual content.

The tipping interface may also include one or more controls for indicating or inputting a reason for a tip.

The tipping interface may also include one or more controls for inputting suggestions or comments relating to the audiovisual content, the streaming technology, the filtering technology, or any aspect of consuming the audiovisual content.

The tipping input, i.e., the information that the consumer inputs into the tipping interface is transmitted to the server, which may then effect a financial transaction, based on the tipping input, to consummate a tip.

Additional details, variants, and embodiments are disclosed herein below.

### BRIEF DESCRIPTION OF THE DRAWINGS

FIG. 1A illustrates an exemplary streaming interface.

FIG. 1B illustrates an exemplary details interface.

FIG. 1C illustrates an exemplary tipping interface.

FIG. 2 illustrates another tipping interface.

FIG. 3 illustrates a flow chart representing one embodiment of the invention disclosed herein.

FIG. 4 illustrates an exemplary tipping interface including an upsell interface.

### DETAILED DESCRIPTION OF THE INVENTION

A method and system for eliciting and receiving tips from a consumer based on the consumer's consumption of media content is disclosed.

Media content, as used herein, is broadly construed to include movies, music, sound, audiovisual content, audio content, visual content, haptic content, sensory content, olfactory content, and any other content, or combination of such content, known in the art.

Content consumer, or consumer, or viewer, or patron, as used herein, refers to any individual or group that consumes media content, e.g., by looking, watching, hearing, touching, feeling, smelling or otherwise experiencing media content.

Media content service, as used herein, may refer to an individual, group of individuals, or entity that sells or rents out physical copies of media content, streams media content, filters media content, facilitates consumption of media content, provides performances of media content, or otherwise provides, facilitates, or improves consumption of media content. Media content services may include, but are not limited to, streaming services such as VidAngel®, Google Play®, Amazon®, or any other entity providing or facilitating consumption of media content.

As used herein, interface element is construed broadly to include, but is not limited to a component, element, or control of an interface, or a combination of such. An element may be virtual, physical, or a combination of such. For example, physical interface elements include, but are not limited to, a computer mouse, computer touchpad, a touchscreen, voice controls, foot controls, keyboard, motion sensors, haptic interface technologies, eye movement recognition, joysticks, controllers, and trackballs, and other physical interface elements known in the art. Virtual interface elements include, but are not limited to, HTML and web browsing controls (e.g., buttons, radio buttons, links, drop downs, menu items, and other web browsing controls known in the art), windowing controls, menus, scroll bars, and other virtual interface elements known in the art.

In one embodiment, a consumer may consume, by viewing and listening to, a movie streamed over the Internet by a media content service that is a streaming service, platform, or technology, e.g., VidAngel®, Google Play®, and Amazon®. The consumer may view the streamed movie on any device known in the art, including but not limited to a television, a computer monitor, any other visual monitor, a smartphone, a tablet, a laptop, a projector, or any other viewing/listening device, platform, or technology known in the art or otherwise available, or any combination of such.

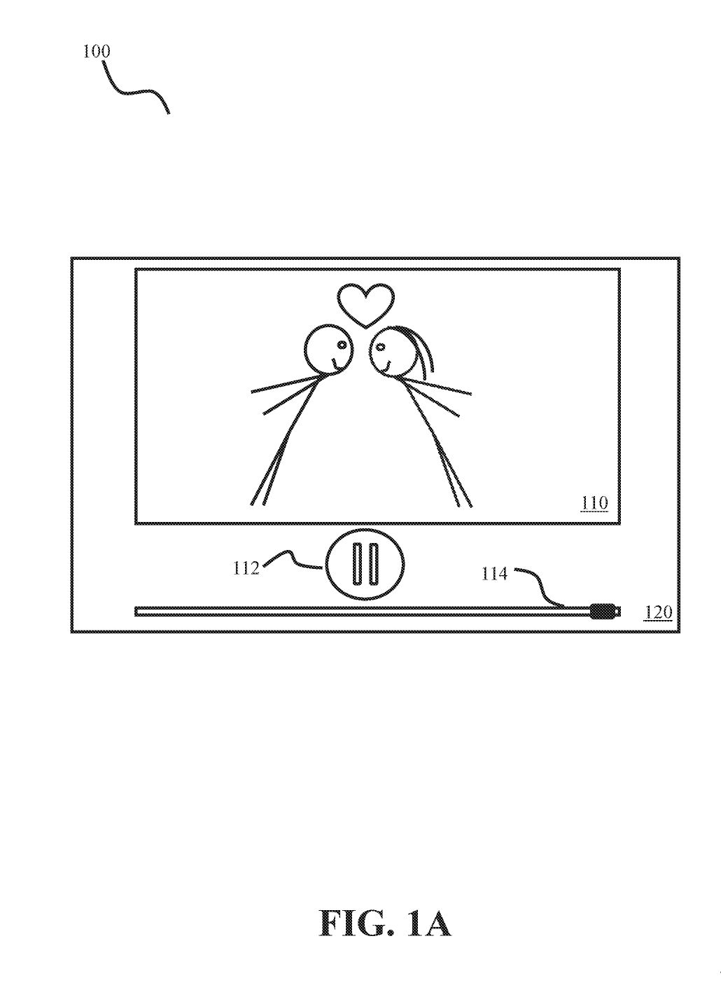

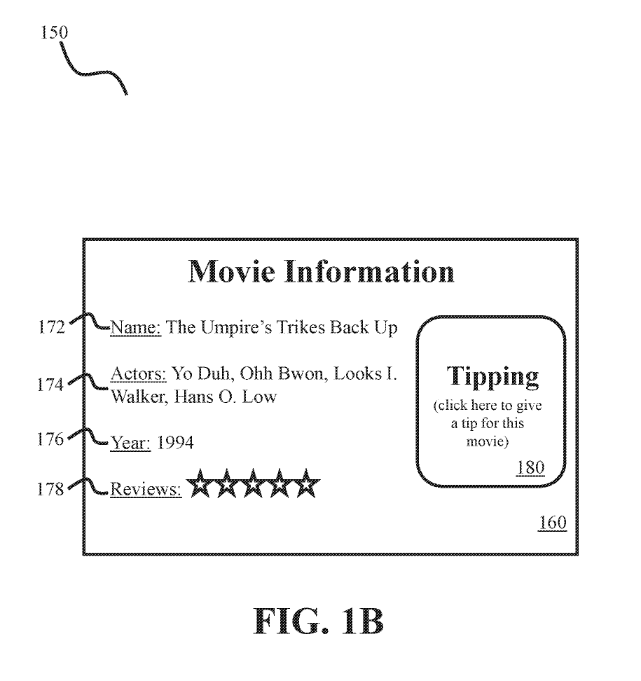

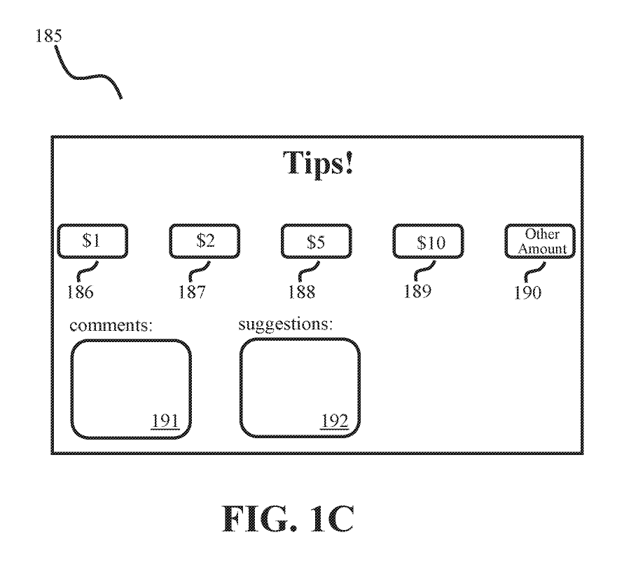

FIG. 1A illustrates an exemplary streaming interface 100. Screen 120 may be a smartphone screen, computer screen, television, tablet screen, or any other visual interface or display known in the art. Display portion 110 may display the visual portion of a streamed movie. Controls 112 and 114 may be interface elements for playing/pausing a movie and/or for selecting a time location in a movie, respectively.

Referring to FIG. 1B, in one embodiment a streaming service may provide a details interface 150 for displaying, or otherwise communicating to or providing for a consumer, details about a movie. Such details may include, but are not limited to, name, actors, year made, reviews, rating, rating reasons, language, release date(s), and other details known in the art. Exemplary details interface 150 may display movie name 172, principal actors 174, movie year 176, and movie reviews 178. The streaming service may provide details interface 150 via a communications network such as the Internet or any other communication network known in the art, or via any other information transfer technology known in the art.

The details interface may be provided to a consumer in conjunction with streaming a movie. In one embodiment, the details interface may be provided before the movie begins. In another interface, the details interface may be provided as part of the beginning of the movie. In other alternatives, the details interface may be provided during the movie (e.g., via web page, or picture-in-picture, or windowing, or second screen, or secondary device), or after the movie has ended, or as the end of the movie, or during an intermission, or on demand upon request from a consumer during the movie, or as audio or another alternate content type during the movie, or through an interface distinct from the movie while the movie is playing, or any combination of such, or in any other manner known in the art.

Details interface 150 may include an interface element 180 for launching, initiating, activating, bringing focus to, or otherwise engaging a tipping interface. Interface element 180 may be an interface element such as a button labeled “Tips,” or “Tipping,” or “Tip.” The interface element for initiating the tipping interface may also be shaped or designed to suggest or otherwise reference tipping, or may include an image, icon, or sound, or other interface element or sub-element that references or suggests tipping.

The tipping interface may be any web, HTML, smartphone, browser, application, app, or other interface known in the art. For example, the tipping interface may be a pop-up dialog box, or an element or set of elements within an HTML web page displayed through a browser, or a screen in a smartphone app, or a screen or portion of a screen in a tablet app, or an audio interface, or a haptic interface, or any other interface technology, solution, or platform known in the art.

FIG. 1C depicts an exemplary tipping interface 185. In one embodiment, tipping interface 185 may be a tipping interface that is launched when a consumer or user selects interface element 180. Buttons 186, 187, 188, 189, and 190 provide options for a user or consumer to tip in the amount of $1, $2, $5, $10, or a custom amount, respectively. Text boxes 191 and 192 may provide an interface for a user or consumer to enter comments or suggestions respectively.

In another embodiment, a tipping interface may be launched, activated, or initiated automatically during playback or consumption of the media content. For example, during streaming of a movie, trigger points associated with the movie may be configured to automatically initiate or launch a tipping interface. In one embodiment, a streaming platform may be configured to launch a tipping interface as soon as the closing credits begin, or as soon as the closing credits end, or at a time point during the closing credits (e.g., 10 seconds, or after the first song during the closing credits completes), or at the intermission of a movie, or even during a movie in some circumstances, or at any other time or location during or in a movie or media content. In general, a tipping interface may be launched or initiated at any point during a movie, such as a time point, or before or after particular content, or before or after particular filtering, or in any other manner known in the art.

In media content with a spatial dimension, e.g., three-dimensional (“3D”) content or virtual reality or otherwise, a tipping interface may be located at a particular location within the content. For example, if media content comprises a 3D movie, a tipping interface may be initiated or launched at a particular time during playback or consumption of a movie, and may be limited to only a particular location within the presented 3D space. In virtual reality media content, a tipping interface may be located at a particular location, e.g., inside a refrigerator in a kitchen, adjacent to a jewel buried in in a mountain cave, or in any other location or manner known in the art.

The tipping interface may include interface elements for eliciting, selecting, and/or consummating a tip. In some embodiments, the tipping interface may include elicitation content, e.g., one or more highlights from the consumed content, a video, audio, or audiovisual message from the content's creator, producer, actors, developer (e.g., special effects personnel, computer generated graphics personnel, set designer, costume artist, makeup artist, choreographer), promoters, critics, or other interested party which may remind the consumer of the quality or highlights of the content, or additional information about the content, or other information or communication designed to encourage the consumer to leave or provide a tip, or at least to inform the consumer of the possibility of, opportunity for, and desirability of leaving or providing a tip. For example, if the content is a movie, elicitation content may include a short video in which the movie producer provides additional insights about the movie, thanks the consumer for choosing to watch, and solicits a tip from the user. In another example, elicitation content may include a short video from a person associated with a media content service, e.g., a streaming platform or filtering solution or platform, in which the person explains the importance of reliable streaming and/or good filtering to increase availability of, customizability of, and access to content for families and others.

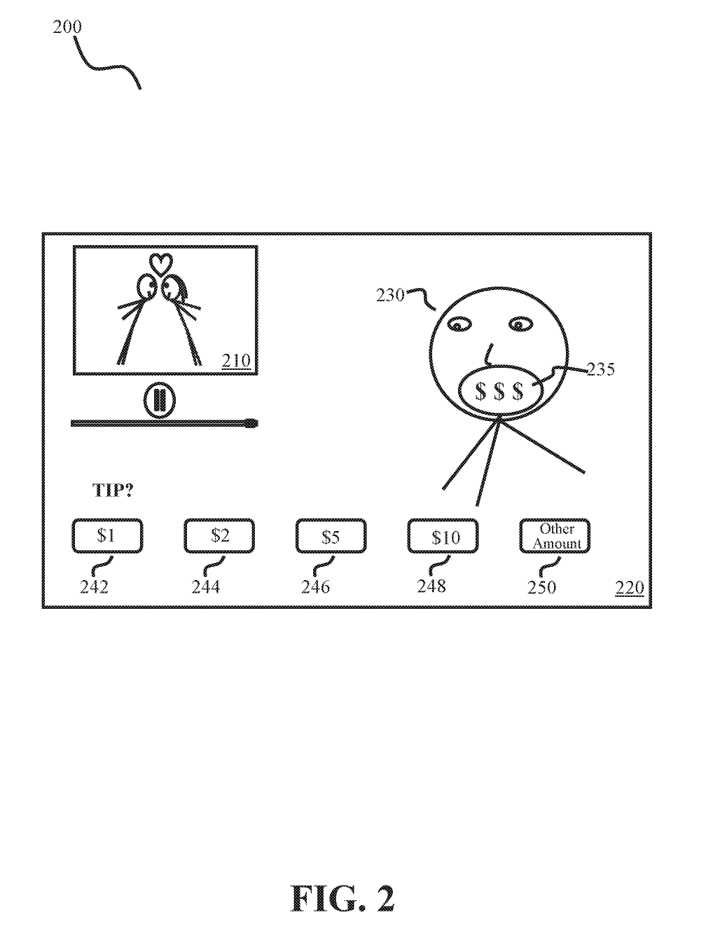

FIG. 2 illustrates exemplary tipping interface 200. Movie playback interface element 210 may be a picture-in-picture format as shown in FIG. 2. Elicitation content 230 may be video in which a producer of the movie being played in interface element 210 discusses the movie or otherwise provides content, information, or interesting or inspiring information 235 about the movie that may incite a consumer to provide a tip by selecting one of interface elements 242, 244, 246, 248, or 250.

The interface element(s) for selecting and consummating a tip may include interface elements that a consumer may use to select an amount for a tip, select a means of paying the tip, select a means of obtaining a receipt for paying the tip, input one or more reasons for the tip (e.g., media content, acting, music, storyline, message, availability, filtering, streaming/technology, inspirational value), select one or more particular uses or applications for a tip (e.g., financing a sequel, improving the streaming interface, bonus for owners of streaming service, developers or providers of filtering solution), select one or more a particular recipients for a tip (e.g., particular actor or performing talent, producer, script writer, music composer, screenwriter), provide a note or communication for inclusion with the tip (e.g., “Thanks for the great movie,” “Really appreciate the reliable streaming service,” “Really loving the filtering granularity and precision,” “Thought the price was fair and reasonable,” “First time using your service—thought the interface was easy to use”), and/or any other interface or information element known in the art that may be associated with or relevant to providing a tip in association with consumption of media content.

In one embodiment, the interface elements for selecting and consummating a tip may include buttons superimposed or overlaid over tip elicitation content, or located beneath tip elicitation content as shown in tipping interface 200. In one embodiment, the tipping interface may include a short video from the producer of a movie, in which the producer speaks and elicits a tip. The tipping interface may include tipping buttons overlaid or superimposed over the video. In one embodiment, the buttons may include multiple buttons respectively labeled “$1 Tip,” “$1.50 Tip” “$2 Tip,” “$3 Tip,” and “Other Amount.” Of course, the number of tipping buttons and the amounts associated with the particular tipping buttons may be configured based on tipping estimate information, which may be determined by any number of factors including, but not limited to, the amount the consumer already paid for the media content, information about the user (e.g., frequency of content consumption, tipping history, income, geography, other demographic information), type of content, tipping amounts (e.g., average, median, high, low, other statistics or functions) from others with similar characteristics or for the same or similar content, time of day, day of the week, time of year, or any other factors known in the art which may related to a consumer's willingness to, ability to, and likelihood of providing a tip.

In one embodiment, a tipping button labeled “Other Amount” may be configured to, when selected, provide one or more additional interface elements for inputting a custom amount for a tip.

In one embodiment, a tipping button may be a one-click interface such that a consumer does not have to provide any additional input to consummate a tip after selecting a tipping button. For example, if a consumer is already logged into, or authenticated on a streaming platform, and has already provided billing or payment information to the streaming platform, then the billing platform may immediately consummate the financial transaction underlying a tip when the consumer selects a particular tipping button. For example, if a consumer selects a button labeled “$1.50 Tip,” then the streaming platform (or other provider of media content) may immediately initiate a transaction to bill $1.50 to a credit card, bank account, Venmo® account, or other financial account associated with the consumer or the consumer's account with the streaming platform or other provider of media content.

In some embodiments, the streaming platform may require a confirmation, e.g., by clicking through a “confirm” dialog or control before consummating the financial transaction underlying the tip.

In some embodiments, a consumer may be presented with a payment interface when the consumer selects or operates a tipping interface element to make a tip. Such interfaces are well known in the art, and may provide input controls for the user to enter credit card information, or bank account information, or other financial transaction information such as PayPal®, Venmo®, or any of other numerous platforms or systems known in the art for engaging in online financial transactions.

In some embodiments, if the consumer desires to enter a tip in a custom amount, e.g., an amount for which a tipping button is not explicitly provided, an “Other Amount” interface element may be provided for a consumer to enter a custom tip amount, or an interface element for entering an amount may be provided when the consumer selects the “Other Amount” control.

In one embodiment, the tipping interface may provide an interface element that informs as to a consumer's tipping history, tips from other consumers for the same or similar media content for which a user is considering tipping, or average tip amounts for movies, genres of movies, types of content, artists, or any other information that may be useful to a consumer in determining whether to make a tip and the amount of a tip.

In some embodiments, a tipping interface may be presented to a consumer only once per playback or consumption of particular content. As described elsewhere herein, such presentation of a tipping interface could be presented at any time or location during playback or consumption of media content.

In other embodiments, a tipping interface may be presented to a consumer multiple times, or in multiple locations, during or in playback or consumption of media content.

In some embodiments, a tipping interface may be launched, activated, or otherwise presented to a user during playback or consumption of media content upon input or interaction from a user selecting or otherwise eliciting presentation of a tipping interface at any time or location during playback or consumption. For example, the tipping interface may be made available as an interface element superimposed over or embedded in a movie, or as an interface element provided in conjunction with a movie, e.g., on a second screen, or on another screen or monitor, or on a smartphone while a movie is playing on a computer monitor or television, or in unused screen or display space, or via sound/voice interface, or in any other manner known in the art whereby a user may enter input or interact with an interface element to launch, initiate, activate, or otherwise engage a tipping interface during playback or consumption of media content.

In one embodiment, launching, initiating, activating, or engaging a tipping interface during content playback or consumption may cause a picture-in-picture effect, or a dual screen effect. For example, for a picture-in-picture effect, during playback of a movie, initiation or launch of a tipping interface may cause the content on a display screen to shrink to a small size and be shown “picture-in-picture,” i.e., covering a part of the tipping interface. A picture-in-picture effect may also result in the tipping interface being shown in a small (or smaller than the area showing the media content) area that covers part of the media content being played.

A dual window effect is similar, except that instead of the tipping interface covering some or all of the content playback, or the content playback covering some or all of the tipping interface, a dual screen effect may size the content playback and tipping interface so that both are visible, at least in part, on the same display or screen.

In one embodiment, at any time that a tipping interface is visible or otherwise presented to a user, the tipping interface, or an associated interface, includes an interface element that, when selected or operated, closes the tipping interface. In some embodiments, the tipping interface, or an associated interface, may also include an interface element for pausing or minimizing the tipping interface.

In some embodiments, a consumer may pay for content independent of whether or not the consumer chooses to tip through a tipping interface. In other embodiments, a consumer may consume content without any required payment, i.e., for free, and may be provided an opportunity to tip through a tipping interface.

In one embodiment, a tipping interface may include an upsell interface and/or upsell content. The upsell interface may include one or more interface elements through which a user may select an upsell. For example, the user may select to tip $20, for which the user may receive a personalized social media, e.g., Facebook®, comment or post from an actor or comedian. Or the user may select to tip $5, for which the user may receive a ring tone comprising a notable audio excerpt from the media content for which the user is tipping.

In general, an upsell interface could include interface elements associated with one or more tipping amounts, and may include interface elements to communicate to a user various tipping amounts and associated upsell incentives, or options for upsell incentives.

An upsell interface may also provide one or more interface elements for selecting or inputting a custom tipping amount. When a custom tipping amount is inputted or selected, the tipping interface may display one or more upsell incentives available at an inputted or selected tipping amount. For example, if a user selects or inputs a $3 tipping amount into the upsell interface, then the upsell interface may provide a drop-down interface element with options including a pre-recorded ring-tone, or a music-download, or a discount to an upcoming event.

Upsell incentives may include, but are not limited to (1) a personalized social media post, e.g., on Facebook®, by an actor or comedian associated with the consumed media content, or from another noteworthy individual, personality, or entity; (2) a CD (compact disc); (3) being followed on social media by an actor or comedian associated with the consumed media content, or by another noteworthy individual personality, or entity; (4) a music or media content download; (5) access to online media content; (6) a discount or free access to an event; (7) a personalized ringtone message from an actor or comedian associated with the consumed media content, or other notable individual, personality, or entity; (8) a pre-recorded ringtone; (9) a ringtone featuring an excerpt from media content associated with the tipping; (10) a product or service or discount on a product or service; (11) additional media content; or any other incentive known in the art.

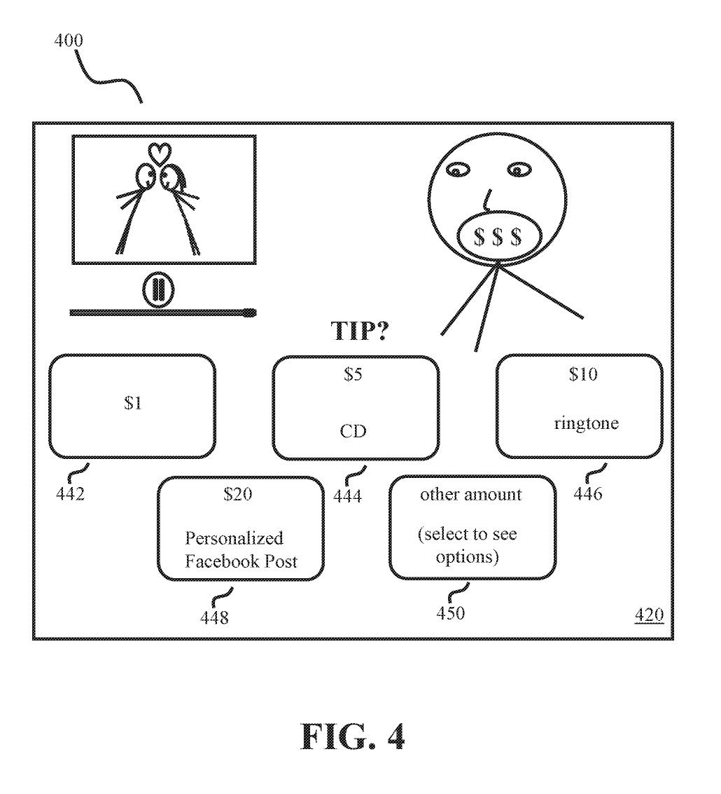

FIG. 4 illustrates an exemplary upsell interface 400. Interface elements 442, 444, 446, 448, and 450 may be selectable by a user for making a tip and thereby obtaining a particular upsell incentive. In one example, no upsell incentive may be associated with a $1 tip selectable via interface element 442. A CD may be associated with tipping $5 by selecting interface element 444. A ringtone may be associated with tipping $10 by selecting interface element 446. A personalized Facebook® post may be associated with tipping $20 by selecting interface element 448. If a user selects interface element 450, tipping interface 400 may be configured to display one or more upsell incentive options associated with one or more tipping amounts or ranges.

In one embodiment, the server may track, store, and/or analyze the tipping results associated with the various tipping interface features, as described herein, that may be presented to a user. The recorded data may include, but is not limited to, particular tipping interface features, user characteristics, content, tipping frequency, and tipping amount. As described herein, tipping features may include, but are not limited to, availability of tipping interface, timing of when tipping interface was presented, frequency of availability of tipping interface, frequency of presentation of tipping interface, mode of presentation of tipping interface (device, screen location, media, sound, visual presentation, elicitation information, elicitation content, length of elicitation content), presented tipping options, presented tipping information (tipping history for a user, tipping data for other users), tipping estimate information, payment options and means, upsell interface and characteristics thereof, and/or any other tipping interface features or characteristics described herein or known in the art.

The server may perform mathematical, statistical, and/or other analysis of the stored tipping results to optimize the expected value of a particular tipping situation. In general, optimization of a particular tipping situation may comprise maximizing the expected value of the tip that a user may provide through the tipping interface. Although optimization generally focuses on a one-time tipping event, optimization may also be directed toward increasing future tipping events, or increasing tipping events across multiple users, or increasing tipping events across multiple content consumptions. Optimization may also be directed toward any other tipping-related goal or objective.

Based on analysis of previous tipping results, and/or in conjunction with other data such as user demographics or viewing/filtering selections, the server may identify, prepare, and present customized tipping interface to a user based on tipping results, user characteristics, or any other factors disclosed herein.

For example, in one embodiment, the server may randomly present one of two tipping interfaces to users for a particular standup comedy content. A first tipping interface may include elicitation content from the comedian associated with the standup comedy content, but without an upsell interface or elicitation. A second tipping interface may include, in addition to elicitation content from the comedian, an upsell interface. The server may store tipping results comprising the average tip received from users based on whether the first or second tipping interface was presented to a user. Based on analysis of this stored tipping results data, the server may determine which tipping interface, or which tipping interface characteristics, to present to a user who may subsequently view the same standup comedy content.

As will be recognized by a person of ordinary skill, many variations of statistical or other analysis of tipping results may be employed in many different ways to determine the features of a tipping interface for presentation to a user.

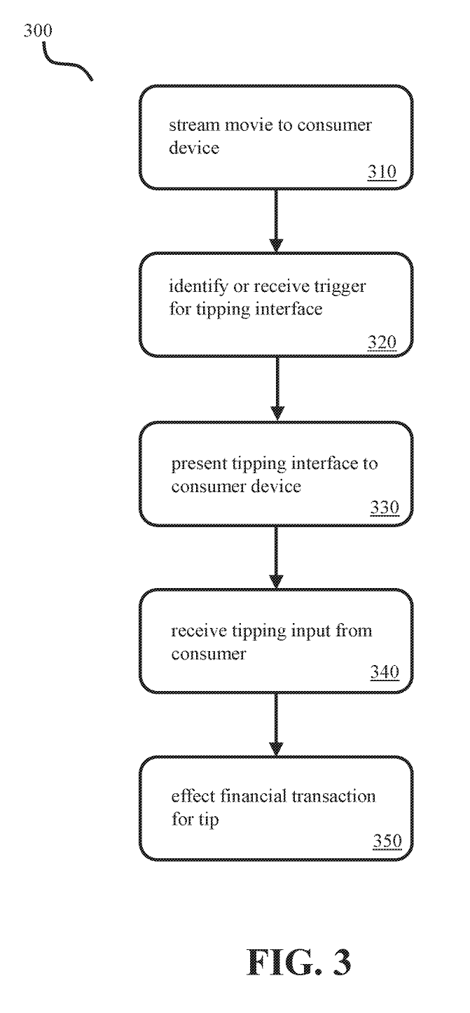

FIG. 3 depicts a flow chart 300 for an exemplary process for eliciting and receiving tips in conjunction with providing media content.

At step 310 a media content provider, which for the sake of example may be movie streaming service, streams a movie to a consumer device. In one embodiment, the streaming service may stream, or begin streaming, a movie to a consumer's device upon request or agreement from a consumer, and generally, but not necessarily always, upon payment or commitment to pay from the consumer. In some embodiments, a movie may be streamed for free. In one embodiment, the consumer may select media content for streaming at a particular price, and may initiate streaming by paying that price electronically through financial information stored by the streaming service, or by inputting financial information in response to an elicitation by the streaming service, or through a financial transaction service such as PayPal® or Venmo® or any other financial transaction system known in the art.

As is well-known in the art, any one of, or a combination of, many streaming technologies may be employed for streaming a movie via the Internet or other communication network to a consumer device. In one embodiment, the movie may be streamed via a packet technology whereby a movie is segmented, or divided, into packets, each representing a segment of the streamed movie. In many packetized streaming technologies, a segment may represent seconds or fractions of a second of the movie.

In one embodiment, the movie streaming service may also provide filtering functionality, such as is provided by the VidAngel® streaming and filtering service. In a packetized streaming platform, the streaming/filtering service may implement filtering by omitting and/or modifying one or more packets associated with the content to be filtered.

As described herein above, in one embodiment, the streaming service may automatically present a tipping interface to a consumer device at a predetermined point in a movie, e.g., the beginning of the credits, or the middle of the credits, or the end of the credits. In a packetized streaming platform, the streaming service may implement this by tagging a packet with a marker to indicate that a tipping interface should be presented before or after that packet is sent, or by inserting a dummy packet without movie content that serves merely as an indicator that a tipping interface should be displayed. The streaming service may check each packet before it is transmitted, presented, or otherwise provided to the consumer device to determine whether a tipping interface should be presented to the consumer device. Of course, if the streaming service is filtering by removing or omitting packets, then it must check to be sure that it does not tag a filtered packet for the tipping interface, but instead tags a packet that will not be filtered, e.g., a preceding or succeeding packet.

At step 320, the streaming service identifies or receives a trigger for a tipping interface. In one embodiment, the streaming service may check each packet being transmitted to a consumer device and may identify a packet as being tagged for initiating a tipping interface, or as being a dummy packet configured to indicate that a dummy interface should be initiated.

Marking, tagging, and identifying a packet may be accomplished in many ways which are well known in the art. In one example, a packet may include a header field or binary switch.

Upon determining that a tipping interface should be presented to the consumer's device, at step 330 the streaming system may transmit a tipping interface to the consumer's device, or transmit a code or command to the consumer's device directing the consumer's device to launch, initiate, activate, present, enable, and/or display a tipping interface. For example, the streaming system may transmit code for a web page or Internet browser to present a tipping interface on the consumer's device.

As discussed herein above, FIGS. 1C and 2 illustrate exemplary tipping interfaces that may be presented via a web browser on a consumer's device, which may be a computer or television display, screen, monitor, or other interface technology or platform known in the art.

Moving now to step 340 in FIG. 3, the streaming system may receive tipping input from the consumer's device. Received tipping input may be transmitted from a consumer's device to the streaming system or other entity, server, computer, device, or system configured to receive tipping input from a consumer. The tipping input may be transmitted via Internet or other communications network as is well known in the art. Received tipping input may include some or all of, but is not limited to, the information described herein above. For example, as shown in FIGS. 1C and 2, a consumer may input, through an input interface in communication with the consumer's device, a tip amount, a reason for the tip, and a comment about the tip. Upon receipt of this tipping input, the streaming system may store the received tipping input temporarily or permanently in a database or other data storage solution known in the art.

Moving now to step 350 in FIG. 3, the streaming system may effect a financial transaction associated with the received tipping input. In one embodiment, the streaming system may have stored, or may be configured to retrieve, credit card, banking, or online financial transaction information associated with the consumer that submitted the tipping input. For example, when a consumer creates an account with a streaming system, or logs in, or determines to request or stream a movie, the consumer may provide information for a credit card to the streaming system and may authorize the streaming system to use such credit card information for all financial transactions in which the consumer engages with the streaming system. The streaming system may store this information and use it to consummate a tipping transaction when tipping input is received from or for a consumer.

Although the examples and embodiments disclosed and described herein focus significantly on streaming a movie via the Internet, the inventions, systems, and methods disclosed herein apply analogously to the other media content, media content services, consumers, consumption technologies, and other variants disclosed herein.

The technology described herein can take the form of an entirely hardware implementation, an entirely software implementation, or implementations containing both hardware and software elements. Components described or characterized as a system may comprise one discrete component, e.g., a server, or may comprise multiple components, e.g., a combination of servers, devices, networking components, software, hardware, and other components known in the art, and configured to communicate with each other and work in conjunction with each other as a system.

What is claimed is:

1. A method, comprising:
providing media content to a consumer;
presenting a tipping interface, related to the media content, to the consumer;
receiving tipping input from the consumer, through the tipping interface, wherein the tipping input includes information associated with a tip.

2. The method of claim 1, further comprising effecting a financial transaction based on the received tipping input.

3. The method of claim 1, wherein the media content is provided to the consumer at no charge.

4. The method of claim 1, wherein the tipping interface includes elicitation content.

5. The method of claim 4, wherein the elicitation content comprises a message from an actor, producer, director, or developer of the media content.

6. The method of claim 1, wherein the tipping input includes at least one reason for the tip.

7. The method of claim 6, wherein the at least one reason for the tip is based on at least one of feature of the media content and/or provision of the content, including streaming, filtering, availability, acting, music, storyline, and inspirational value.

8. The method of claim 1, wherein the tipping input includes a use or recipient for the tip.

9. The method of claim 8, wherein the use is one of financing a sequel for the media content, improving streaming for the media content, improving filtering for the media content, improving distribution of the media content, and improving affordability of the media content.

10. The method of claim 8, wherein the recipient is one of an actor associated with the media content, a script writer associated the media content, a singer or music player associated with the media content, a music composer associated with the media content, a screenwriter associated with the media content, a provider of streaming associated with the media content, and a provider of filtering associated with the media content.

11. The method of claim 1, wherein the tipping input includes at least one comment or suggestion based on at least one of the media content, streaming quality, and filtering quality.

12. The method of claim 1, wherein the tipping interface includes tipping estimate information.

13. The method of claim 12, wherein the tipping estimate information is based at least in part on the consumer's frequency of consuming media content, the consumer's tipping history, the consumer's income, the consumer's geographic location, a characteristic of the media content, tipping data for other consumers for the media content, tipping data for other consumers for content other than the media content, tipping data for other consumers that share at least one common characteristic with the consumer.

14. The method of claim 1, wherein the media content includes closing credits and the tipping interface is presented at the beginning of or during the closing credits.

15. The method of claim 1, wherein the tipping interface is presented at one or more trigger points during the media content.

16. The method of claim 1, wherein the tipping interface includes an upsell interface.

17. The method of claim 1, wherein presenting the tipping interface to the consumer comprises making the tipping interface available for launch at the consumer's discretion during some or all of the media content.

18. The method of claim 1, wherein presenting the tipping interface comprises determining characteristics of the tipping interface based on tipping results.

19. A system, comprising:
a computer server configured to:
provide media content to a consumer;
determine to present a tipping interface, related to the media content, to the consumer;
present the tipping interface to the consumer;
receive tipping input from the consumer, through the tipping interface, wherein the tipping input includes information associated with a tip.

20. The system of claim 19, wherein:
the media content is provided to the consumer at no charge;
the tipping interface includes elicitation content;
the tipping input includes at least one reason for the tip;
the tipping input includes a use or recipient for the tip;
the tipping input includes at least one comment or suggestion based on at least one of the media content, streaming quality, and filtering quality;
the tipping interface includes tipping estimate information; and
the tipping interface is presented at one or more trigger points during the media content.
